(19) United States
(12) Patent Application Publication
(10) Pub. No.: US 2008/0049841 A1
(43) Pub. Date: Feb. 28, 2008

(54) Hardware Method for Performing Real Time Multi-Level Wavelet Decomposition

(76) Inventor: Eric Jeffrey, Richmond (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/467,051

(22) Filed: Aug. 24, 2006

(51) Int. Cl. H04B 1/66

(52) U.S. Cl. 375/240.19; 375/240.29

(57) ABSTRACT

A graphics controller for performing real-time multi-level wavelet decomposition is provided. The graphics controller, includes an interface for receiving streaming data. The graphics controller includes wavelet decomposition circuitry configured to receive the streaming data from the interface. The wavelet decomposition circuitry includes a single low pass filter and a single high pass filter. A plurality of shift register banks receiving output from the low pass filter are included, as well as a multiplexer receiving input from the plurality of shift register banks and the streaming data, wherein the streaming data is unbuffered between the interface and the multiplexer. Control logic for selecting output from the multiplexer and enabling shift registers of the plurality of shift register banks to transmit data for input to the multiplexer is also include in the wavelet decomposition circuitry. A method for performing a multi-level wavelet decomposition in hardware is also provided.

### BACKGROUND

Battery operated imaging devices having an image sensor and graphical display are increasingly popular. Cell phones and personal data assistants, as well as digital cameras, are a few examples of such devices incorporating a digital imaging device and electronic display.

As more such devices enter the market, it is increasingly important to provide increased capability and functionality to provide distinguishing features. Unfortunately, many functional improvements require additional hardware accessories, which adversely affect the size, power consumption, and price of the imaging device. It would therefore be desirable to provide enhanced functionality without significantly affecting the cost of production.

As more handheld devices have camera functionality, the processing of the image data in an efficient manner to provide the highest quality display becomes a significant feature. For example, pictures taken in low light conditions include a significant amount of noise in the image. One technique for reducing noise in an image is by performing a wavelet transform on the image data to break the image down into different frequency components without losing timing information. However, the current implementation of the hardware needed for accomplishing this functionality requires too much chip real estate and power requirements, especially for lower end cell phones with camera capability. Furthermore, the ability to provide the functionality in real time is not feasible especially for lower end portable devices as the data must be buffered, which add to the expense and complexity of the devices.

As a result, there is a need to solve the problems of the prior art to provide multi-level wavelet decomposition circuitry in order to de-noise or compress an image on a handheld device in real-time.

### SUMMARY

Broadly speaking, the present invention fills these needs by providing a graphics controller and imaging device having multi-level wavelet decomposition functionality. It should be appreciated that the present invention can be implemented in numerous ways, including as a process, an apparatus, a system, a device, or a method. Several inventive embodiments of the present invention are described below.

In one embodiment, a method for performing a multi-level wavelet decomposition in hardware is provided. The method includes receiving data from a streaming source into a first bank of shift registers without buffering the data and transferring the data from the first bank of shift registers through a multiplexer to both a first filter and a second filter. The method further includes transmitting data from the first filter to a plurality of shift register banks, and enabling the plurality of shift bank registers to transmit the filtered data to the multiplexer. The filtered data or the data from the first bank of shift registers is selected and then the selected data is transmitted to the plurality of shift bank registers after passing through the first filter. The method operations are then repeated for successive streaming data frames.

In another embodiment, a graphics controller for performing a real-time multi-level wavelet decomposition is provided. The graphics controller, which may be referred to as a mobile graphics engine, includes an interface receiving streaming data. The graphics controller includes wavelet decomposition circuitry configured to receive the streaming data from the interface. The wavelet decomposition circuitry includes a single low pass filter and a single high pass filter, each of which include multiplying and adding functionality. A plurality of shift register banks receiving output from the low pass filter are included in the wavelet decomposition circuitry, as well as a multiplexer receiving input from the plurality of shift register banks and the streaming data, wherein the streaming data is unbuffered between the interface and the multiplexer. Control logic for selecting output from the multiplexer and enabling shift registers of the plurality of shift register banks to transmit data for input to the multiplexer is also included in the wavelet decomposition circuitry.

In yet another embodiment, a device capable of performing a real-time multi-level wavelet decomposition is provided. The device includes a central processing unit (CPU) and a mobile graphics engine, wherein the mobile graphics engine includes wavelet decomposition circuitry configured to receive the streaming data from the interface, the wavelet decomposition circuitry having a single low pass filter and a single high pass filter. The wavelet decomposition circuitry further includes a plurality of shift register banks receiving output from the low pass filter and a multiplexer receiving input from the plurality of shift register banks and the streaming data. The streaming data is unbuffered between the interface and the banks of shift registers and between the banks of shift registers and the multiplexer. Control logic for selecting output from the multiplexer and enabling shift registers of the plurality of shift register banks to transmit data for input to the multiplexer are provided in the wavelet decomposition circuitry. The wavelet decomposition circuitry also includes a random access memory configured to store output from the single high pass filter. The device includes a bus providing a communication pathway between the CPU and the mobile graphics engine.

The advantages of the present invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a high-level simplified schematic diagram of a device having the capability to perform real-time multi-level wavelet decomposition in accordance with one embodiment of the invention.

FIG. 2 is a simplified schematic diagram showing further details of the mobile graphics engine in accordance with one embodiment of the invention.

FIG. 3A is a simplified schematic diagram of the multi-level wavelet decomposition logic in accordance with one embodiment of the invention.

FIG. 3B is a simplified schematic diagram the multi-level wavelet decomposition logic for a two dimensional discrete wavelet transform for an image processing application in accordance with one embodiment of the invention.

FIG. 4 is a timing diagram illustrating the flow of data through the multi-level wavelet decomposition logic of FIG. 3.

FIG. 5 is a simplified schematic diagram of the logic within the single high pass filter and the single low pass filter in accordance with one embodiment of the invention.

FIG. 6A is a simplified schematic diagram graphically displaying the results of a two dimensional wavelet decomposition in accordance with one embodiment of the invention.

FIG. 6B is an example of actual image data that has been decomposed three levels in accordance with one embodiment of the invention.

### DETAILED DESCRIPTION

In the following description, numerous specific details are set forth in order to provide a thorough understanding of the present invention. However, it will be apparent to one skilled in the art that the present invention may be practiced without some of these specific details. In other instances, well known process operations and implementation details have not been described in detail in order to avoid unnecessarily obscuring the invention.

The wavelet transform provides a time-frequency representation of a signal. It has numerous practical applications, such as signal de-noising and compression. The Discrete Wavelet Transform (DWT) is a well known algorithm for transforming discrete signals into their DWT coefficients. The DWT analyzes the signal at different frequency bands with different resolutions by decomposing the signal into coarse approximation and detail information. The DWT employs two sets of functions, called scaling functions and wavelet functions, which are associated with low pass and high pass filters, respectively. The decomposition of the signal into different frequency bands is simply obtained by successive high pass and low pass filtering of the time domain signal. The original signal x[n] is first passed through a halfband high pass filter g[n] and a low pass filter h[n]. After the filtering, half of the samples from each filtered signal can be eliminated according to Nyquist's rule, since each signal now has a frequency range of π/2 radians/s instead of π radians/s. The signals can therefore be down sampled by 2, simply by discarding every other sample. This constitutes one level of decomposition and can mathematically be expressed as follows:

$${y}_{high} ( k ) = {\sum }_{n} x [ n ] \cdot g [ 2 k - n ]$$

$${y}_{low} ( k ) = {\sum }_{n} x [ n ] \cdot h [ 2 k - n ]$$

where y_{high}[k] and y_{low}[k] are the outputs of the high pass and low pass filters, respectively, after down sampling by 2.

This decomposition halves the time resolution since only half the number of samples now characterizes the entire signal. However, this operation doubles the frequency resolution, since the frequency band of the signal now spans only half the previous frequency band, effectively reducing the uncertainty in the frequency by half. The above procedure, which is also referred to as sub-band coding, can be repeated for further levels of decomposition. At each level, the filtering and down sampling will result in half the number of samples (and hence half the time resolution) and half the frequency band spanned (and hence double the frequency resolution) than the previous level.

As an example, suppose that the original signal x[n] has 512 sample points, spanning a frequency band of zero to π rad/s. At the first decomposition level, the signal is passed through the high pass and low pass filters, followed by down sampling by 2. The output of the high pass filter has 256 points (hence half the time resolution), but it only spans the frequencies π/2 to π rad/s (hence double the frequency resolution). These 256 samples constitute the first level of DWT coefficients. The down sampled output of the low pass filter also has 256 samples, but it spans the other half of the frequency band, frequencies from 0 to π/2 rad/s. The low pass filtered signal is then passed through another set of the same low pass and high pass filters for further levels of decomposition. The output of the second low pass filter, followed by down sampling, has 128 samples spanning a frequency band of 0 to π/4 rad/s, and the output of the second high pass filter, followed by down sampling, has 128 samples spanning a frequency band of π/4 to π/2 rad/s. The second high pass filtered signal constitutes the second level of DWT coefficients. This signal has half the time resolution, but twice the frequency resolution of the first level signal. In other words, the time resolution has decreased by a factor of 4, and the frequency resolution has increased by a factor of 4 as compared to the original signal. The low pass filter output is then filtered once again for further decomposition through additional filters. This process can continue (though it can stop after any number of levels of decomposition) until two samples are left. For this specific example there would be 8 levels of decomposition, each level having half the number of samples of the previous level. The DWT of the original signal is then obtained by concatenating all coefficients starting from the last level of decomposition (remaining two samples, in this case). The DWT will then have the same number of coefficients as the original signal. The high pass and low pass filters, g[n] and h[n], can be chosen by the user. The high pass and low pass filters will typically have the same cutoff frequency, which will be half of the maximum frequency of the original signal. It should be appreciated that it is not possible to realize perfect high pass or low pass filters, so there is always a tradeoff between filter accuracy and size. To implement the algorithm in hardware for operation in real-time, the desired number of levels of decomposition must first be known. Then, for each level, a set of high pass and low pass filters must be implemented. It should be noted that even though the high pass and the low pass filters output new data on every clock, the output side shift registers only shift in this data every 2^{nd} clock in order to achieve the down sampling by a factor of 2. Thus, as described below, a novel technique for performing the multi-level wavelet decomposition is provided that avoids the use of the multiple sets of high and low pass filters and provides data from the output side shift registers at each clock. Thus, the embodiments can apply this functionality in real time to live streaming data without requiring the buffering of the data. These characteristics enable the functionality to be incorporated into a portable handheld device having video/image capture capability.

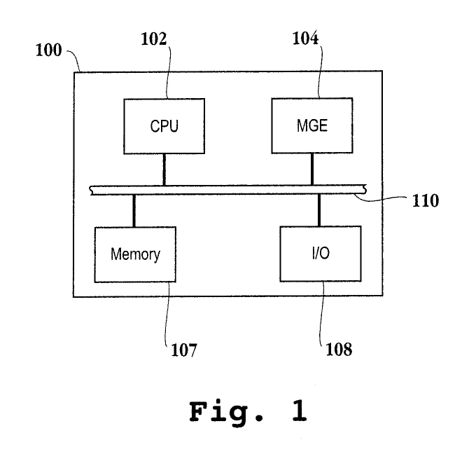

FIG. 1 is a high-level simplified schematic diagram of a device having the capability to perform real-time multi-level wavelet decomposition in accordance with one embodiment of the invention. Device 100 includes central processing unit (CPU) 102 and mobile graphics engine (MGE) 104. It should be appreciated that MGE 104 may be referred to as a graphics processing unit or graphics controller. Device 100 further includes memory 107 and input/output (I/O) block 108. Each of CPU 102, MGE 104, memory 107, and I/O 108 are in communication with each other over bus 110. One skilled in the art will appreciate that device 100 may be any suitable handheld portable electronic device, e.g., a cell phone, a personal digital assistant, a web tablet, etc. The real-time, multi-level wavelet decomposition circuitry within MGE 104, described further below, can be used to reduce noise in any image data, which may be viewed on a display of device 100. In addition, the embodiments described herein may also be applied to compression and other data processing schemes.

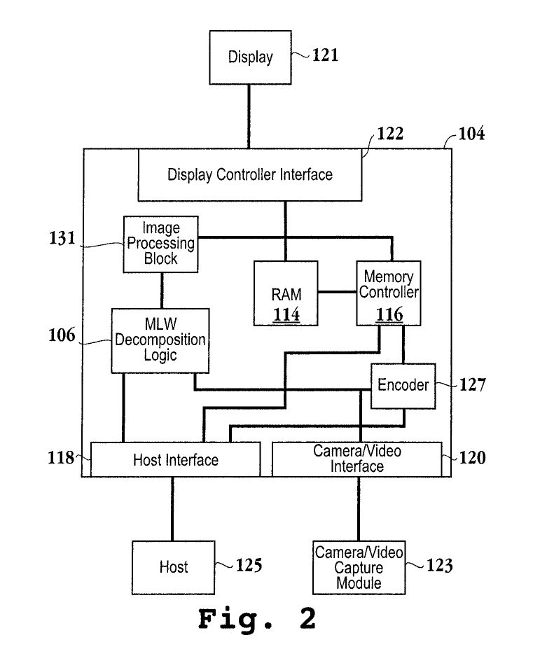

FIG. 2 is a simplified schematic diagram showing more details of the mobile graphics engine in accordance with one embodiment of the invention. MGE 104 includes multi-level wavelet decomposition logic 106. Multi-level wavelet (MLW) decomposition logic 106 includes logic to provide a time-frequency representation of a signal. Image processing block 131 is included within MGE 104. Image processing block 131 provides functionality for any type of algorithm that operates in the wavelet domain, such as image de-noising. Typically, some operation is performed on the wavelet coefficients and then an inverse wavelet transform is performed to get back to the “image domain”, so that the image can be viewed on a display. Included within MGE 104 are host interface (I/F) 118 and camera/video I/F 120, which are configured to receive signals from host 125 and a camera/video capture module 123, if available. For example, as mentioned above, the embodiments described herein may be incorporated with a portable electronic device having camera/video functionality. Display controller I/F 122 provides output to display device 121. It should be appreciated that display device 121 is not limited to a computer monitor and may be a television screen in another embodiment. Random access memory (RAM) 114 and corresponding memory controller 116 provide storage for MGE 104. In one embodiment, encoder 127 is included to compress image data captured by camera module 123 and stored in memory 114. Encoder 127 may compress the data according to any known compression standard, e.g., the Joint Photographic Expert Group (JPEG), Motion Picture Expert Group (MPEG), etc. The compression method may even be one that is based on the DWT (eg. JPEG2000). It should be appreciated that the timing control signals and data lines communicating between the blocks within MGE 104 are shown as a single line between the blocks for ease of illustration, however, there may in fact be several address, data, and control lines between the blocks and/or over a bus within the MGE.

Still referring to FIG. 2, MLW decomposition logic 106 may be used for signal de-noising and compression in one embodiment. One skilled in the art will appreciate that the discrete wavelet transform (DWT) is an algorithm for transforming discrete signals into their DWT coefficients. As mentioned above, the DWT analyzes the signal at different frequency bands with different resolutions by decomposing the signal into coarse approximation and detail information. The DWT embodied herein employs two sets of functions, called scaling functions and wavelet functions, which are associated with low pass and high pass filters, respectively. Previously, limitations of chip real estate have prevented the use of real time multi-level wavelet decomposition due to the size of the circuitry in order to perform the decomposition. The embodiments described below provide details for an implementation using a single high pass filter and a single low pass filter irrespective of the number of levels of wavelet decomposition to be performed.

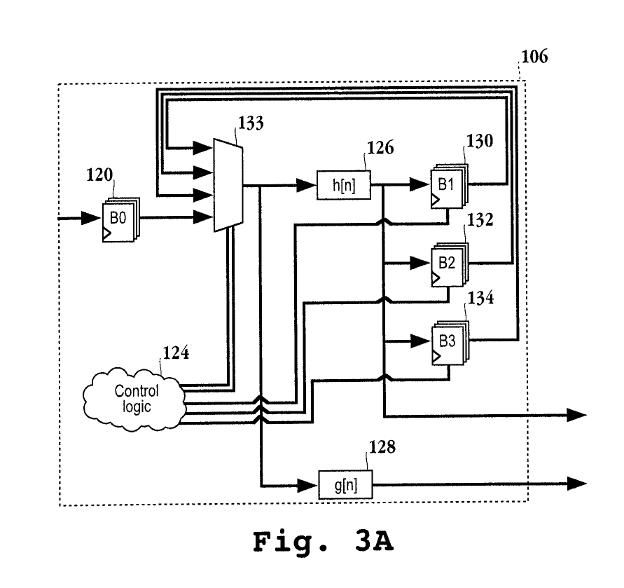

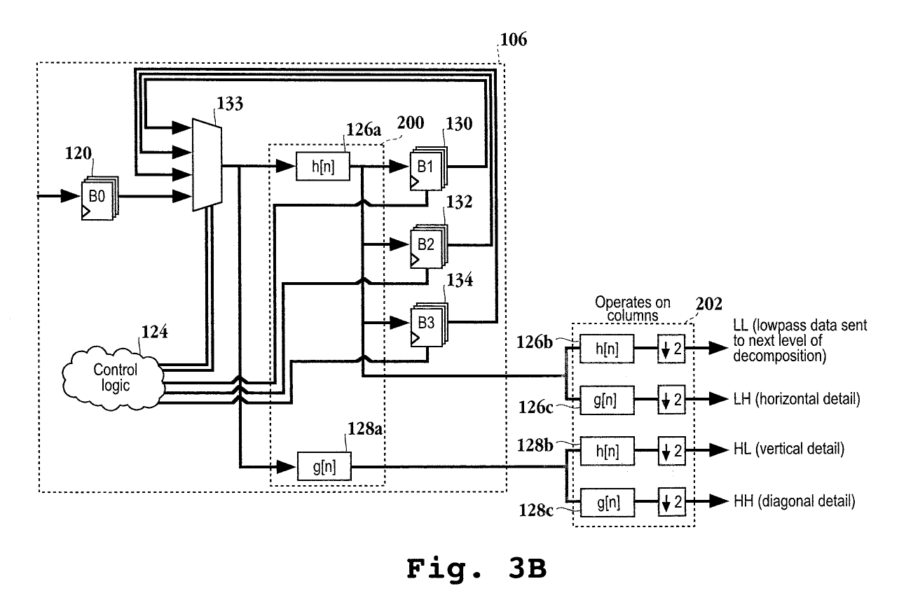

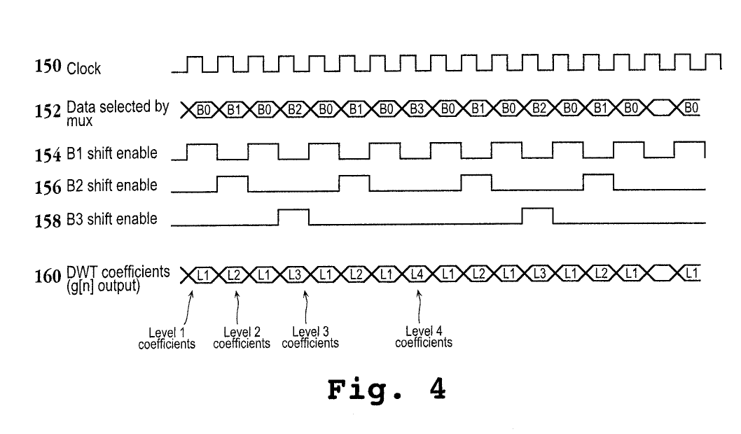

FIG. 3A provides a simplified schematic diagram of the multi-level wavelet decomposition logic in accordance with one embodiment of the invention. Multi-level wavelet decomposition logic 106 includes a first bank of shift registers 120, as well as shift register banks 130, 132, and 134. The output of each corresponding shift register bank is input into multiplexer 133. Control logic 124 provides a select signal to determine the output of multiplexer 133. The output from multiplexer 133 is transmitted to high pass filter 128 and low pass filter 126. It should be appreciated that while four levels of decompositions are illustrated in FIG. 3A the architecture may be extended to any number of levels of decomposition without adding any more filters, i.e., high pass filters or low pass filters. Additional shift registers in each bank may be added to accommodate any level of decomposition. The embodiment in FIG. 3A takes advantage of the fact that the output of the filters is down-sampled by two each time. Control logic 124 controls multiplexer 133 to select data from one of the shift register banks and send that data to the corresponding filters. In addition, control logic 124 controls the shift enable signals to each set of shift register banks. As discussed with regard to FIG. 4, the data from shift register bank 120 is selected half of the time, the data from shift bank register 130 is selected one-quarter of the time, and the data from shift bank register 132 is selected one-eighth of the time, while the data from shift bank register 134 is selected one-sixteenth of the time, through select and enable signals provided by control logic 124. It should be noted that data is processed from the output side shift registers at each clock cycle rather than having wasted clock cycles, e.g., skipping clock cycles to achieve the down sampling. It should be further appreciated that as long as there are enough shift register banks, this architecture can be used for an infinite number of levels of decomposition. In one embodiment, control logic block 124 controls when each of the shift registers in the banks of shift registers shift in new data through the select and enable signals generated therein. When data from shift register bank 120 (new data) is selected by multiplexer 133, bank 130 will shift in the new data on the next clock cycle. When data from bank 130 is selected by multiplexer 133, bank 132 will shift in new data on the next clock cycle. This sequence continues for all the banks of shift registers to achieve the down sampling. It should be noted that the data coming into shift register bank 120 may be live streaming data and need not be buffered as data is processed each clock cycle through the embodiments described herein. Thus, the data can be processed in real time.

FIG. 3B is a simplified schematic diagram of the multi-level wavelet decomposition logic for a two dimensional discrete wavelet transform for an image processing application in accordance with one embodiment of the invention. One skilled in the art will appreciate that two dimensional image data is processed by expanding the one dimensional process illustrated in FIG. 3A. FIG. 3B illustrates a block diagram for a single level of decomposition for a two dimensional signal. As illustrated the signal passes through two stages of filters 200 and 202. The first stage 200 of filters 126a and 128a operates on rows of the two dimensional image data. The second stage of filters 126b and 126c, and 128b and 128c, operates on columns of the two dimensional image data. As illustrated in block 202 the filtered data is downsampled by a factor of two. As illustrated, the downsampled output from filter 126b will be used for the next level of decomposition, while the downsampled output from filters 126c, 128b, and 128c provides the horizontal, vertical, and diagonal detail, respectively.

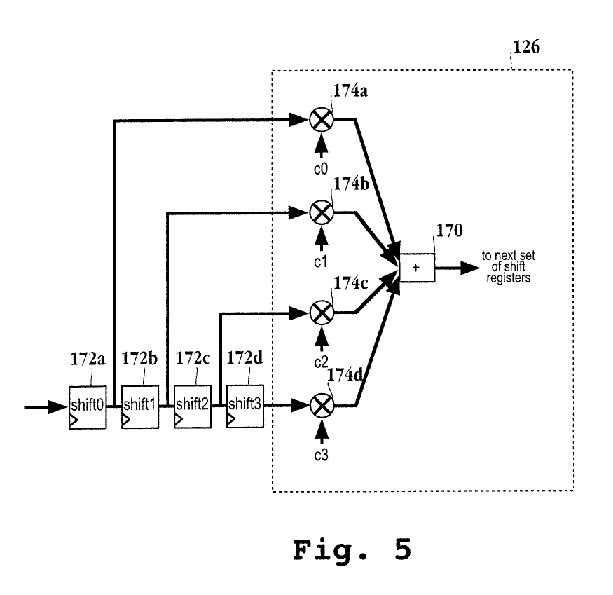

One skilled in the art will appreciate that the circuitry for accomplishing the two dimensional decomposition will be embodied in the MLW decomposition block of FIG. 2. In one embodiment, there will be buffering capability provided between the first stage of filters 200 and the second stage of filters 202, as the second stage of filters operates on column data and enough lines of data are buffered to feed the second stage filters. Thus, if the second stage filters are as illustrated with reference to FIG. 5, then the buffer would be large enough to store 4 lines of data. In this embodiment, once the first four lines of the buffer are filled, then it is possible to start reading out the data vertically and sending the data to the second stage filters. In addition, data from the first stage filters can overwrite data in the buffer that is no longer needed, in order to maintain the real time aspects of these embodiments. It should be appreciated that a corresponding buffer may exist for the data emanating from each of high pass filter 128 and low pass filter 126.

FIG. 4 is a timing diagram illustrating the flow of data through the multi-level wavelet decomposition logic of FIG. 3. In FIG. 4, clock cycle 150 is provided having a certain clock period. In line 152, the data selected by multiplexer 133 of FIG. 3 is provided. As can be seen, the data from shift register bank 120 of FIG. 3 (B0) is selected every other clock cycle, while the data from shift register bank 130 (B1) is selected every fourth clock cycle, the data from shift register bank 132 (B2) is selected every eighth clock cycle, while the data from shift bank register 134 (B3) is selected every sixteen clock cycles. The filters remain inactive once every 16 clock cycles in this embodiment, which is a drastic improvement over skipping every other clock cycle on the output side shift registers. Shift enable signals 154, 156, and 158, which are provided through control logic 124 of FIG. 3, determine the frequency with which the data is selected for the different shift register banks. As illustrated in FIG. 4, shift enable signal 154 is asserted once every other clock period for clock cycle 150, shift enable signal 156 is asserted once every four clock periods for clock cycle 150, and shift enable signal 158 is asserted once every eight clock periods for clock cycle 150. In line 160, the output of the high pass filter and the corresponding coefficients used for the DWT calculation are provided. It should be appreciated that levels L1-L4, correspond to shift register banks B0-B4, respectively. That is, L1 coefficients are generated by high pass filtering the data in shift register bank B0, L2 coefficients are generated by high pass filtering the data in shift register bank B1, and so on. As mentioned above, the coefficients are provided by the output of the high pass filter for the corresponding decomposition level. These coefficients can be stored in RAM or used directly in compression, denoise, or other algorithms.

FIG. 5 is a simplified schematic diagram of the logic within the high and low pass filters in accordance with one embodiment of the invention. For exemplary purposes, FIG. 5 illustrates the adders and multipliers for low pass filter 126 of FIG. 3, however, it should be appreciated that the adders and multipliers for low pass filter 126 similarly apply to high pass filter 128 of FIG. 3. The difference between the filters will be the value of filter coefficients C0 through C3. Low pass filter 126 includes four multipliers 174a-d, each in communication with an output from successive shift registers 172a-d, of a bank of shift registers. The multipliers 174a-d will take the output from the corresponding shift register 172a-d, multiply that output with the corresponding filter coefficient and then sum each of the corresponding products through adder 170.

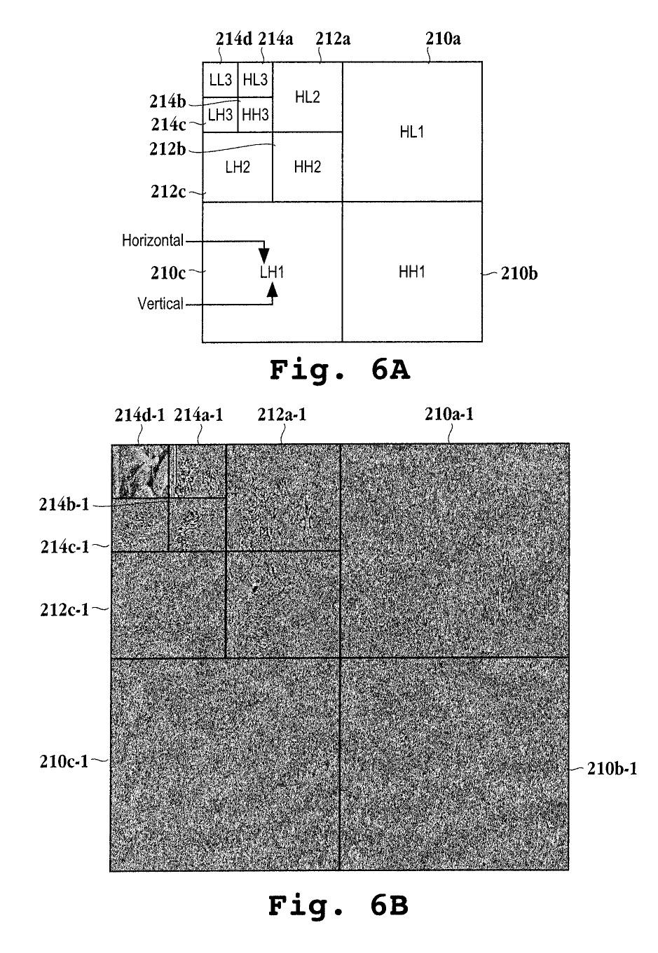

FIG. 6A is a simplified schematic diagram graphically displaying the results of a two dimensional wavelet decomposition in accordance with one embodiment of the invention. Squares 210a-c represent the vertical, diagonal, and horizontal details of the first level decomposition, while squares 212a-c represent the vertical, diagonal, and horizontal details of the second level decomposition. Squares 214a-c represent the vertical, diagonal, and horizontal details of the third level decomposition and square 214d represents the low pass image data from the third level of decomposition. FIG. 6B is an example of actual image data that has been decomposed three levels in accordance with one embodiment of the invention. Squares 210a-1 through 214d-1 correspond to the squares of FIG. 6A, however the decomposed image data is illustrated in the corresponding squares. Squares 210a-1-214c-1 are a visual representation of the DWT coefficients, while square 214d-1 represents the 3^{rd} stage low pass filtered image.

It should be appreciated that while a bank of four shift registers are illustrated through the embodiments described herein, any number of shift registers may be included in each bank. Of course, the number of multipliers in the filters will correspond to the number of shift registers in each of the banks of shift registers. The number of multipliers used to realize the filters depends on the desired filter characteristics. Through the embodiments described herein the number of multipliers, which occupy a relatively large amount of chip real estate, is drastically reduced so that a real-time multi-level wavelet decomposition circuit is possible. Any number of decomposition levels may be accommodated by adjusting the number of shift register banks.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated. Further, the manipulations performed are often referred to in terms such as producing, identifying, determining, or comparing.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for performing a multi-level wavelet decomposition in hardware, comprising method operations of:
a) receiving data from a streaming source into a first bank of shift registers without buffering the data;
b) transferring data from the first bank of shift registers through a multiplexer to both a first filter and a second filter;
c) transmitting data from the first filter to a plurality of banks of shift registers;
d) enabling the plurality of banks of shift registers to transmit the filtered data to the multiplexer;
e) selecting from the filtered data and additional data from the first bank of shift registers; and
f) transmitting the selected data to the plurality of banks of shift registers after filtering; and
g) repeating d)-f) for successive frames of streaming data.

2. The method of claim 1, wherein the method operation of enabling the plurality of banks of shift registers to transmit the filtered data to the multiplexer includes,
generating a plurality of enable signals, wherein one of the plurality of enable signals is asserted.

3. The method of claim 2, wherein data from the plurality of banks of shift registers is processed at each clock cycle, and wherein the method includes,
storing filtered frames of the streaming data; and
compressing the filtered frames of the streaming data for display.

4. The method of claim 2, wherein the first filter is a low pass filter and the second filter is a high pass filter.

5. The method of claim 4, further comprising:
storing output of the second filter in memory.

6. The method of claim 1, wherein the method operation of transmitting data from the first filter to a plurality of shift register banks includes,
multiplying the data by a plurality of coefficients; and
summing results of the multiplied data.

7. The method of claim 6 wherein the method operation of multiplying the data by a plurality of coefficients provided by the second filter includes,
accessing the plurality of coefficients which are stored in a storage element of the hardware.

8. A graphics controller for performing a real-time multi-level wavelet decomposition, comprising:
an interface receiving streaming data;
a bank of shift registers receiving the streaming data directly from the interface;
wavelet decomposition circuitry configured to receive the streaming data from the interface, the wavelet decomposition circuitry including,
a single low pass filter;
a single high pass filter;
a plurality of banks of shift registers receiving output from the low pass filter;
a multiplexer receiving input from the plurality of banks of shift registers and the bank of shift registers, wherein the streaming data is unbuffered between the interface and the bank of shift registers; and
control logic for selecting output from the multiplexer and enabling shift registers of the plurality of banks of shift registers to transmit data for input to the multiplexer.

9. The graphics controller of claim 8, wherein the single high pass filter and the single low pass filter both include a plurality of multipliers in communication with a single adder.

10. The graphics controller of claim 9, wherein an amount of the plurality of multipliers is equal to an amount of the shift registers in each of the plurality of banks of shift registers.

11. The graphics controller of claim 8, further comprising:
an encoder for compressing stored data previously processed by the wavelet decomposition circuitry.

12. The graphics controller of claim 8, further comprising:
a memory region storing output from the single high pass filter for use in the single low pass filter.

13. The graphics controller of claim 8, wherein enable signals generated by the control logic are configured to enable one of the plurality of banks of shift registers to transmit data.

14. The graphics controller of claim 8, wherein valid data is output from the plurality of banks of shift registers at each clock cycle.

15. The graphics controller of claim 8, wherein the graphics controller is incorporated into a portable electronic device having camera functionality.

16. A device capable of performing a real-time multi-level wavelet decomposition, comprising:
a central processing unit (CPU);
a mobile graphics engine, the mobile graphics engine including,
wavelet decomposition circuitry configured to receive the streaming data from the interface, the wavelet decomposition circuitry including,
a single low pass filter;
a single high pass filter;
a plurality of banks of shift registers receiving output from the low pass filter;
a multiplexer receiving input from the plurality of banks of shift registers and an interface for receiving streaming data, wherein the streaming data is unbuffered between the interface and the multiplexer; and
control logic for selecting output from the multiplexer and enabling shift registers of the plurality of banks of shift registers to transmit data for input to the multiplexer;
a random access memory configured to store output from the single high pass filter; and
a bus providing a communication pathway between the CPU and the mobile graphics engine.

17. The device of claim 16, further comprising:
a video capture module providing the streaming data.

18. The device of claim 16, wherein the mobile graphics engine includes a bank of shift registers to receive the streaming data.

19. The device of claim 16, wherein the single high pass filter and the single low pass filter both include a plurality of multipliers in communication with a single adder, and wherein an amount of the plurality of multipliers is equal to an amount of the shift registers in each of the plurality of shift register banks.

20. The device of claim 16, further including an encoder configured to retrieve data processed through the wavelet decomposition circuitry from the random access memory and compress the data for transmission to the CPU.
